(19) United States
(12) Patent Application Publication
(10) Pub. No.: US 2002/0080422 A1
(43) Pub. Date: Jun. 27, 2002

(54) Scanning method for adjusting Y-axis modulation transfer function

(76) Inventor: Shih-Huang Chen, Hsinchu (TW)

Correspondence Address: J.C. Patents, Inc., 1340 Reynolds Ave., Suite 114, Irvine, CA, 92614, US

(21) Appl. No.: 09/746,818

(22) Filed: Dec. 22, 2000

(51) Int. Cl. H04N 1/04; H04N 1/46

(52) U.S. Cl. 358/474; 358/505

(57) ABSTRACT

A scanning method for adjusting Y-axis modulation transfer function, suitable for use in a scanner. The scanner performs at least one stepping movement between two neighboring pixels. Each stepping movement requires a shifting time to move the chasis to a fixed position. The scanning method thus generate a shutter signal which lasts a shutter time after the surge of a transmission gate signal is generated.

### BACKGROUND OF THE INVENTION

1. Field of the Invention

The invention relates in general to a method to adjust a Y-axis modulation transfer function. More particularly, the invention relates to a scanning method for adjusting a Y-axis modulation transfer function.

2. Description of the Related Art

The scanning method used in a scanner is normally continuously scanning according to the movement of a chasis. In this kind of scanning method, as the chasis is moving during scanning, the brightness or color of each pixel is easily changed as being affected the brightness or color of the neighboring pixel. In other words, the scanning method which simultaneously displaces and scans will have problem of image superposition.

To resolve the above problem, the prior art provides another scanning method. In this scanning method, the chasis is displaced to be stationary at a fixed point. After a sufficient time of exposure, the exposure of the sensor is stopped, and the chasis is moved to a next fixed point. As the moving time of the chasis and the exposure time of the sensor are separate, the scanning time is much longer.

### SUMMARY OF THE INVENTION

The invention provides a scanning method for adjusting Y-axis modulation transfer function (MTF). This method provides a document scanning operation simultaneously with the movement of the chasis to reduce the image superposition in Y-axis.

In the method provided by the invention, a scanner performs at least one stepping displacement between two neighboring pixels. Each stepping displacement requires one displacement time to move the chasis to a fixed position. After surge of the transmission gate is generated, a shutter signal lasting for a period of a shutter time is generated.

The shutter signal is used to activate the shutter function of the sensor. The shutter time is adjusted according to specific condition. For example, the shutter time can be either a displacement time for moving the chasis to the fixed position, or which can be obtained the result from the pre-corrected scanning.

Both the foregoing general description and the following detailed description are exemplary and explanatory only and are not restrictive of the invention, as claimed.

### BRIEF DESCRIPTION OF THE DRAWINGS

FIG. 1A shows a displacement of a chasis used in a first embodiment of the invention;

FIG. 1B shows a relationship between the Y-axis displacement and time for the chasis;

FIG. 1C is a diagram showing the sequence of FIG. 1A;

FIG. 2A shows a displacement of a chasis in the second embodiment of the invention;

FIG. 2B shows the relationship between the Y-axis displacement and the time;

FIG. 2C shows the sequence diagram of FIG. 2A;

FIG. 3A shows the sequence diagram of a third embodiment; and

FIG. 3B shows the assembly of the pixel brightness of the third embodiment as shown in FIG. 3A.

### DESCRIPTION OF THE PREFERRED EMBODIMENTS

Before a further description of this invention, the basic operation of the scanner motor is depicted. In a scanner, a chasis is continuously moving from its exterior feature. In fact, the motor that drives the chasis is actually moving in a stepping manner. Therefore, the actual movement of the chasis is a stepping movement or displacement. In other words, within a displacement time, the chasis is moved from one fixed position to another fixed position, and stays in this fixed position for a period of time. After this period of time, the chasis is moved to another fixed position.

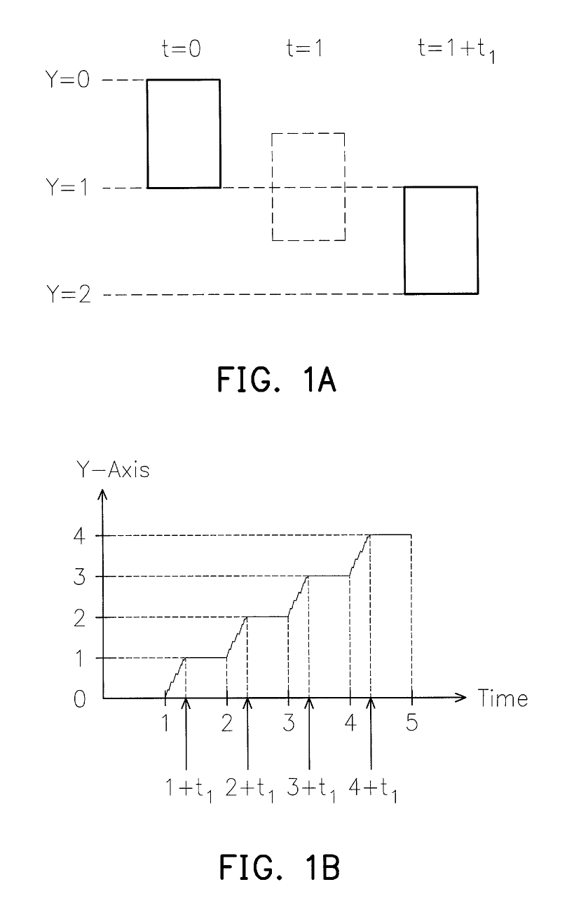

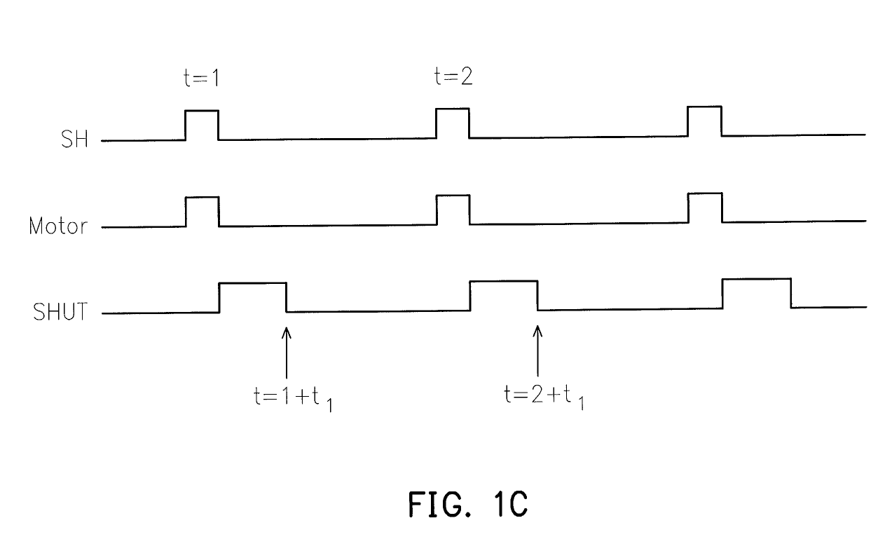

In FIG. 1A, the displacement of a chasis in a first embodiment is illustrated. In this embodiment, a fill step optical resolution method is used for scanning. That is, the movement between each pixel depends on one rotation of the stepping motor. Each pixel is the lowest resolution for scanning. In addition, the displacement time for the chasis is t1. Thus, in this embodiment, when t=0, the chasis is located at zero of Y-axis. When t=1, the chasis starts moving. When t=1+t1, the chasis reaches the next fixed point. That is, the chasis is displaced to Y=1 at Y-axis.

In FIG. 1B, a relationship between the displacement of the chasis along the Y-axis and the displacement is shown. The chasis is not at the fixed position right at the beginning of the displacement. It approaches the fixed position after a period of time (t1 in this embodiment). Thus, referring to FIG. 1C, between t=1 to t=2, the sensor to scan the pixels located between Y=1 to Y=2 mix the brightness and color of the pixels between Y=0 to Y=1 because of this period of displacement time.

In FIG. 1C, to resolve the above pixel mixture problem, a shutter signal (SHUT) can be generated after the surge of the transmission gate signal is generated. The period of the surge of two transmission gate signals is the exposure time of the sensor. The shutter signal continuously shut the shutter for a shutter time. The shutter time is equivalent to the displacement time t1. It is to be noted that this shutter time is not necessary equivalent to the displacement. However, it is adjusted according to specific condition. For example, the shutter time can be adjusted by analyzing the result obtained by pre-correcting the scan. The shutter time can also be adjusted according to the required clearness of the pixel.

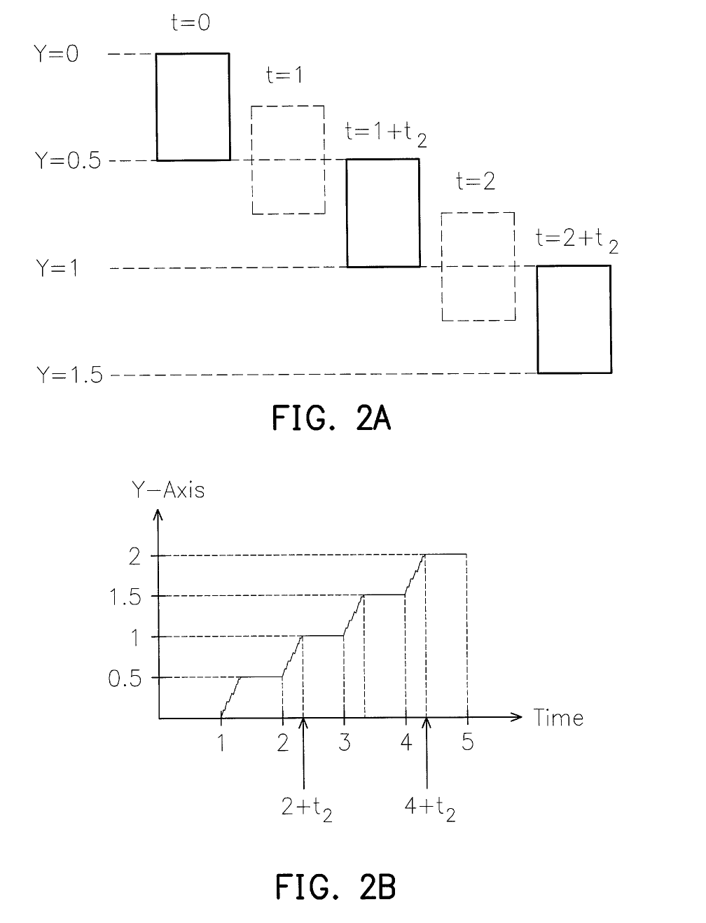

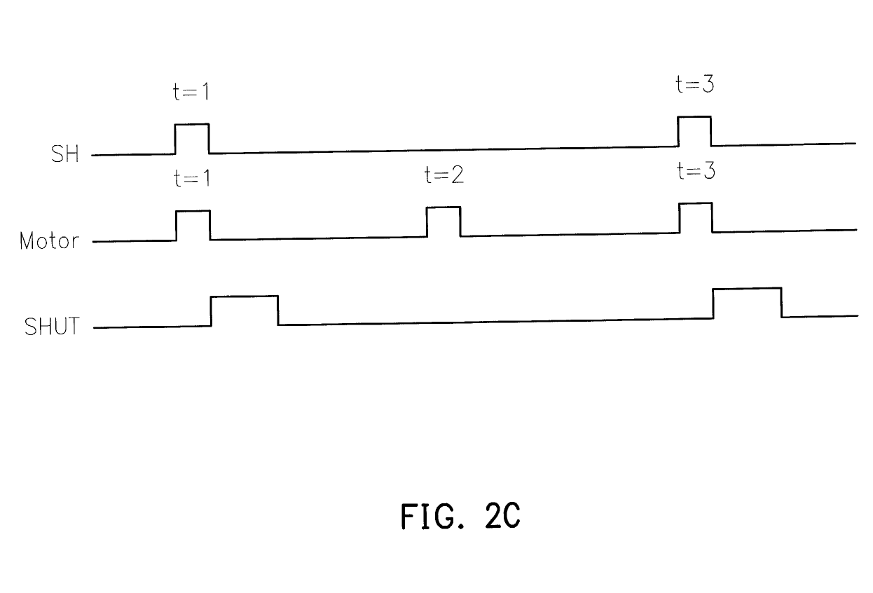

In FIG. 2A, a second embodiment of the displacement of the chasis is illustrated. The full step half optical resolution method is used for scan. That is, the displacement between each pixel is based on one rotation of the stepping motor. Two pixels are referred as the lowest resolution for scan. In addition, the displacement time for the chasis is t2. Referring to FIG. 2B, the relationship between the displacement of the chasis along Y-axis and the displacement time is shown. When t=0, the chasis is located at zero of Y-axis. When t=1, the chasis starts moving. When t=1+t2, the chasis reaches to the next fixed point, that is, Y=0.2 at Y-axis. Similarly, when t=2, the chasis starts moving again, and the chasis reaches the next fixed point when t=2+t2. This next fixed point is the Y=1 point.

Referring to FIG. 2C, the sequence diagram of the embodiment as shown in FIG. 2A is illustrated. Similarly, the duration of the surge of two transmission gate signals is the exposure time of the sensor. The shutter signal generates after the surge of each transmission gate signal. The shutter is shut for a shutter time.

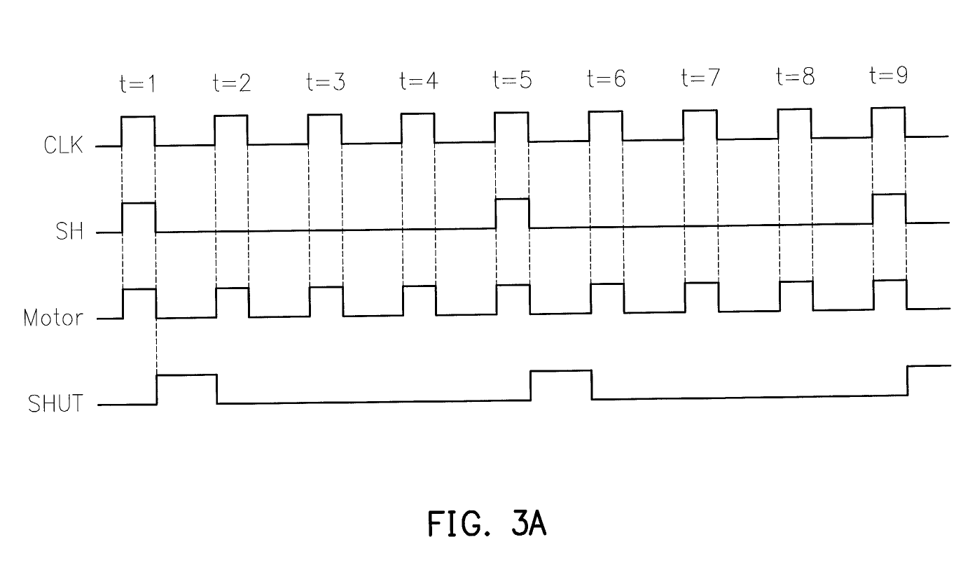

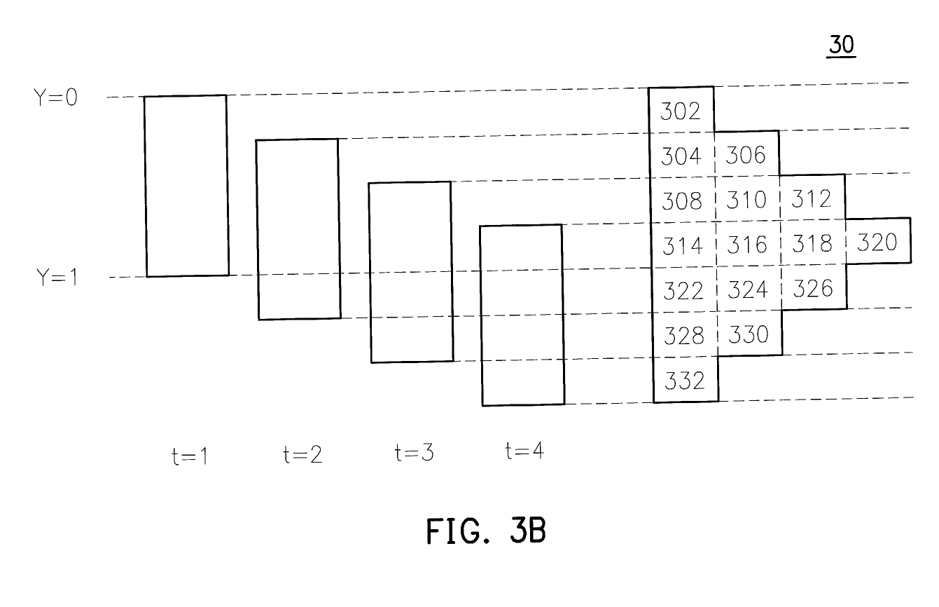

Referring to FIG. 3A, a sequence diagram of a third embodiment is illustrated. In this embodiment, a 1/4 step optical resolution method is used for scan. That is, the displacement between each pixel is based on four rotations of the stepping motor. Each pixel is referred as the lowest resolution for scan. The CLK signal is used to denote the signal of the clock interval. It is known from FIG. 3A, between t=1 to t=5, the sensor performs an exposure operation on a pixel. During this period of time, the motor rotates once at t=1, t=2, t=3 and t=4, respectively.

FIG. 3B shows the assemble of brightness of pixel in the embodiment as shown in FIG. 3A. When t=1, t=2, t=3 and t=4, the assembly of the measured brightness is shown as the polygonal area 30 assembled by areas 302 to 332. The area assembled by areas 302, 304, 308 and 314 is the brightness obtained between Y=0 and Y=1. The area assembled by areas 322 to 332 is the brightness after Y=1. As the shutter signal (SHUT) is used while sensor is functioning at the beginning, after the surge of the transmission gate signal at t=1, a shutter signal is output and lasts for a shutter time. However, as the Y-axis is continuously scanned, the position of the sensor while scanning can be adjusted by adjusting the initial position of the chasis. Thus, the relative position of the sensor and the pixel can be adjusted. That is, using the shutter to block the sensor, the brightness effect at t=1 can be suppressed. As a result, the effect of brightness at t=1 is the same as it is at t=2, t=3 and t=4.

If the brightness at the areas 302, 304, 308 and 314 is reduced, it effectively reduces the brightness of the areas 314, 322, 328 and 332. The areas having brightness superposition with other pixel include six areas of 322 to 332. After the brightness of the areas 314, 322, 328 and 332 is reduced, the superposition areas are reduced by three area (areas 322, 328 and 332). Therefore, using the method provided by the invention can effectively reduce the interference from other pixels during scanning, and the image clarity along the Y-axis is much enhanced. That is, the effect of the Y-axis modulation transfer function is enhanced.

It is appreciated that the above scanning conditions are only raised as an example of the invention. Other scanning conditions can also be applied in this invention to enhance the effect of the Y-axis modulation transfer function.

According to the above, the invention uses the shutter function of the sensor to reduce the image superposition along Y-axis during the continuous scan of the scanner. The effect of Y-axis modulation transfer function is enhanced.

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

What is claimed is:

1. A scanning method for adjusting Y-axis modulation transfer function, applied to a scanner that performs at least one stepping displacement during two neighboring pixels, and each stepping displacement requiring a displacement time to move a chasis to a fixed position, wherein a shutter signal lasting for a shutter time is generated after a surge of a transmission gate signal is generated.

2. The scanning method according to claim 1, wherein the shutter time is equivalent to the displacement time.

3. The scanning method according to claim 1, wherein the shutter time is obtained by analyzing a result obtaqined by pre-correcting scanning.
